(19) United States
(12) Patent Application Publication
(10) Pub. No.: US 2022/0351619 A1
(43) Pub. Date: Nov. 3, 2022

(54) Emergency Vehicle Audio Detector Apparatus

(71) Applicant: Abdelrahim Osama Amer, Cumming, GA (US)

(72) Inventor: Abdelrahim Osama Amer, Cumming, GA (US)

(21) Appl. No.: 17/661,298

(22) Filed: Apr. 29, 2022

Related U.S. Application Data
(60) Provisional application No. 63/181,726, filed on Apr. 29, 2021.

(51) Int. Cl. G08G 1/0965

(52) U.S. Cl. CPC G08G 1/0965

(57) ABSTRACT

An emergency vehicle audio detection apparatus uses phase lock loop technology to detect when an emergency vehicle is approaching. Emergency vehicle audio detector apparatus uses heads up display and a plurality of microphones mounted internally or externally on the vehicle to detect and warn drivers of emergency vehicles which may be approaching. The present apparatus uses phase lock loop techniques and filtering to determine if a difference between a plurality of signals is zero. The phase lock loop technique can distinguish if a sound picked up by a microphone is meaningful and then notify a driver of oncoming emergency vehicles. In some embodiments, a mute wire in an emergency vehicle audio detector apparatus could be installed to interact with a mute pin on a head unit display to mute audio volume once the emergency vehicle audio detector apparatus is activated. In some embodiments, a programming chip could be installed which would interact with an audio and a heads up display so that the display will give more information about an emergency vehicle in an area. In some embodiments, a speaker to audibly tell a driver to pull over could be installed in an emergency vehicle audio detector apparatus. In some embodiments, a display could have arrows showing from which direction an emergency vehicle is coming.

### CROSS REFERENCE TO RELATED APPLICATIONS

This application claims the benefit of provisional patent application Ser. No. 63/181,726 filed Apr. 29, 2021.

### TECHNICAL FIELD

The present invention relates generally to the field of audio detectors and more specifically to emergency vehicle audio detectors.

### BACKGROUND

The following is a tabulation of some prior art that presently appears relevant:

| Patent Number | Kind Code | Issue Date | Patentee |
|---|---|---|---|
| U.S. Pat. No. 10,210,756 | B2 | Feb. 19, 2019 | Arunachalam |
| U.S. Pat. No. 11,231,905 | B2 | Jan. 25, 2022 | Cordourier |
| | | | Maruri et al. |
| U.S. Pat. No. 11,244,564 | B2 | Feb. 8, 2022 | Seifert |

### Patent Publications

| Publication No. | Date | Applicant |
|---|---|---|
| US 2015/0371539 | Dec. 24, 2015 | Hawkins, SR. |
| US 2017/0291543 | Oct. 12, 2017 | Goldman-Shenhar et al. |
| WO 2022/073676 | Aug. 19, 2021 | Hook |

### Non-Patent Literature

“Emergency Vehicle Alert System” https://actu.epfl.ch/news/attention-assist-mercedes-system-to-alert-drowsy-d/

Drivers can be unaware of emergency vehicles in their surroundings due to playing music too loud or having hearing impairment issues. Emergency response times may be affected by unaware drivers. Automobiles may crash into emergency vehicles that drivers are unaware of.

Current alert systems use the internet to advise drivers. This is undesirable because there are areas of low reception. Some autonomous vehicles sense the emergency vehicle and either stop the car or move the car to the side of the road. These systems are expensive and only available in new cars, not for aftermarket use. Some prior arts use existing microphones and cameras in the vehicle to interact with the emergency vehicles via a complex installation to the head unit display in the vehicle.

Other prior arts use networks to determine information about emergency vehicles in a particular area. These rely on emergency vehicles giving an alert to a particular network and are non-responsive if an alert is not given. What is needed is a simple, stand-alone system that can easily be retrofitted into any car and that uses audio signal processing to distinguish emergency vehicles' sounds.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

An emergency vehicle audio detector apparatus does not need to be integrated into a vehicle's interface and can be installed in new or aftermarket vehicles. Emergency vehicle audio detector apparatus uses heads up display and a plurality of microphones mounted internally or externally on the vehicle to detect and warn drivers of emergency vehicles which may be approaching. The present apparatus uses phase lock loop techniques and filtering to determine if a difference between a plurality of signals is zero. The phase lock loop technique can distinguish if a sound picked up by a microphone is meaningful and then notify a driver of oncoming emergency vehicles.

Installing an emergency vehicle audio detector apparatus is no more difficult than installing an aftermarket backup camera. There is no need to take a vehicle apart or to hire a professional installer.

In some embodiments, a mute wire in an emergency vehicle audio detector apparatus could be installed to interact with a mute pin on a head unit display to mute audio volume once the emergency vehicle audio detector apparatus is activated.

In some embodiments, a programming chip could be installed which would interact with an audio and a heads up display so that the display will give more information about an emergency vehicle in an area.

In some embodiments, a speaker to audibly tell a driver to pull over could be installed in an emergency vehicle audio detector apparatus.

In some embodiments, a display could have arrows showing which direction an emergency vehicle is coming from.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### Advantages

Accordingly several advantages of one or more aspects are as follows: an emergency vehicle audio detection apparatus alerts drivers of emergency vehicles in a vicinity of a vehicle. An emergency vehicle audio detection apparatus does not need to be integrated into a vehicle's interface and can be easily installed on new or existing vehicles. An emergency vehicle audio detection apparatus is simple and inexpensive to produce. An emergency vehicle audio detection apparatus does not rely on a network to interact with drivers, making the apparatus more reliable in rural areas. An emergency vehicle audio detection apparatus does not rely on alerts from an emergency vehicle. In some embodiments, a mute wire is used to interface with a vehicle and mute any audio from the vehicle. Other advantages will be readily apparent from the drawings and description.

### BRIEF DESCRIPTION OF THE DRAWINGS

The accompanying drawings, which are incorporated in and constitute a part of this disclosure, illustrate various embodiments of the present disclosure. Furthermore, the drawings may contain text or captions that may explain certain embodiments of the present disclosure. This text is included for illustrative, non-limiting, explanatory purposes of certain embodiments detailed in the present disclosure.

FIG. 1 generally shows a side view of an emergency vehicle audio detector as installed in a vehicle.

FIG. 2 generally shows an emergency vehicle audio detector display as a stand-alone unit.

FIG. 3 generally shows an emergency vehicle audio detector display as part of a head unit of a vehicle.

FIG. 4 generally shows a schematic of a phase lock loop integrated circuit for use in an emergency vehicle audio detector apparatus.

FIG. 5 generally shows a schematic of an emergency vehicle audio detector apparatus.

### DETAILED DESCRIPTION

As a preliminary matter, it will be readily understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure.

Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

While embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

It is intended that the scope of patent protection is to be defined by the issued claim(s) rather than the description set forth herein. Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail. Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While multiple embodiments of the disclosure may be described, modifications, adaptations, and other implementations are possible. For example, substitutions, additions, or modifications may be made to the elements illustrated in the drawings. Accordingly, the following detailed description does not limit the disclosure. Instead, the proper scope of the disclosure is defined by the appended claims. While the apparatus described is shown as mounted in an automobile, it should be understood that the apparatus could be used in other vehicles.

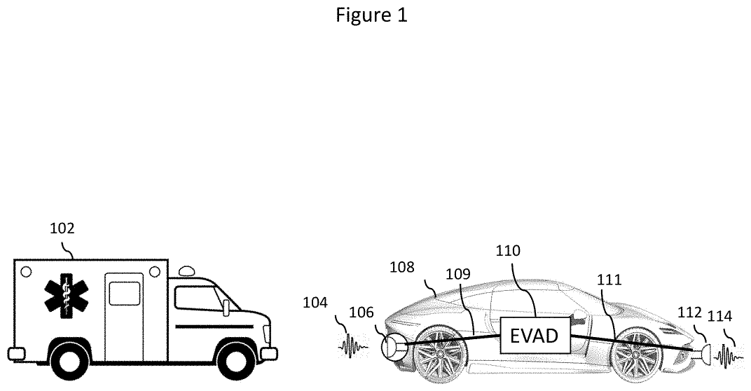

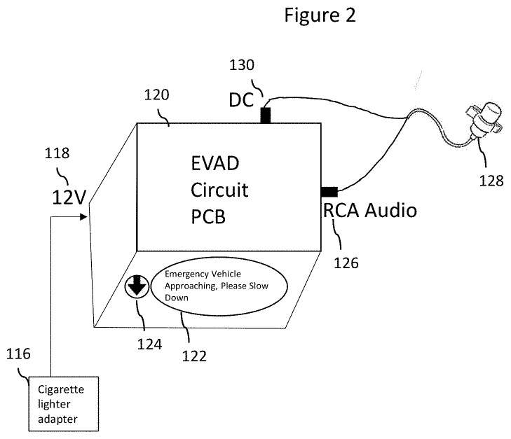

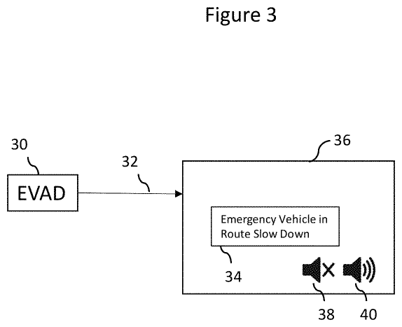

FIG. 1 generally shows a side view of an emergency vehicle audio detector as installed in a vehicle. An emergency vehicle 102, is depicted here as an ambulance, but it could be a fire engine or other emergency vehicle. Emergency vehicle 102 emits a distinctive sound wave 104. Sound wave 104 is received by microphone 106. Microphone 106 is installed in a vehicle 108. A vehicle 108, is depicted here as an automobile, but could be any type of vehicle, including trucks or tractor trailer units, or the like. Microphone 106 is shown installed on the rear bumper but could be installed in any reasonable manner on vehicle 108. The output 109 of microphone 106 goes to an emergency vehicle audio detector apparatus 110. In some embodiments, a microphone 112 is installed in a front section of the vehicle 108. A microphone 112 receives a sound wave 114 which comes from the emergency vehicle 102. The output 111 of microphone 112 goes to the emergency vehicle audio detector apparatus 110. The emergency audio detector apparatus determines that the sound wave is coming from the emergency vehicle 102 and outputs a signal to either a stand-alone display unit as in FIG. 2 or a display unit as integrated into a vehicle's head unit as in FIG. 3.

FIG. 2 generally shows an emergency vehicle audio detector display as a stand-alone unit designed to be fixedly or removably attached to a dashboard, a windshield, or otherwise installed in a vehicle. An emergency vehicle audio detector (EVAD) apparatus 120 is shown as a printed circuit board. The emergency vehicle audio detector 120 has a display 122 which uses a flashing display circuit to display an emergency message in flashing lights. In some embodiments, at least one flashing LED warning light 124 further warns the driver from which direction an emergency vehicle is coming. The emergency vehicle audio detector apparatus has a 12-volt input which comes from a cigarette lighter adapter 116 in a vehicle. At least one microphone 128 is mounted in the vehicle. The at least one microphone 128 is connected to an RCA audio plug 126 which connects to the emergency vehicle audio detector 120. The emergency vehicle audio detector has a direct current output 130 for the at least one microphone 128.

FIG. 3 generally shows an emergency vehicle audio detector (EVAD) display as part of a head unit 36 of a vehicle. The emergency vehicle audio detector 30 produces an output 32 when it detects that an emergency vehicle is nearby. A head unit 36 is built into a vehicle. When an output 32 is sent to the head unit 36, the head unit 36 displays a warning message 34. In some embodiments, mute 38 and unmute 40 signals are sent to the head unit to mute all audio in the vehicle when an emergency vehicle is nearby.

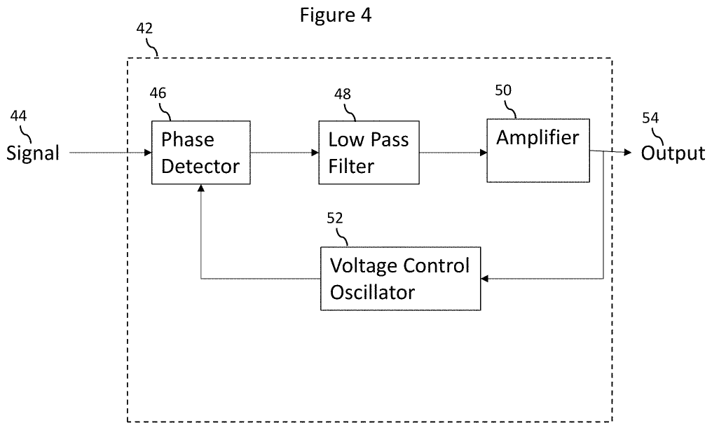

FIG. 4 generally shows a schematic of a phase lock loop integrated circuit 42 for use in an emergency vehicle audio detector apparatus. A phase lock loop is a control system that generates an output signal where the phase of the output signal is related to the phase of an input signal. The voltage control oscillator 52 generates a periodic signal and the phase detector 46 compares the phase of that signal with the phase of the input signal 44, adjusting the voltage control oscillator 52 to keep the phases matched. The input signal 44 and output 54 frequencies are kept the same. A phase lock loop 42 can track an input frequency or generate a frequency that is a multiple of the input frequency. Phase lock loops are widely employed in telecommunications, radios, computers, and other electronic applications.

A signal 44 comes into the phase lock loop 42 and is detected by a phase detector 46. The output of the phase detector 46 is connected to a low pass filter 48. The low pass filter 48 is connected to an amplifier 50 which produces an output 54. The output from the amplifier also goes into a voltage control oscillator 52 for frequency modulation. The output of the voltage control oscillator 52 goes back to the phase detector 46. One example of a phase lock loop integrated circuit can be found commercially as IC MC14046B.

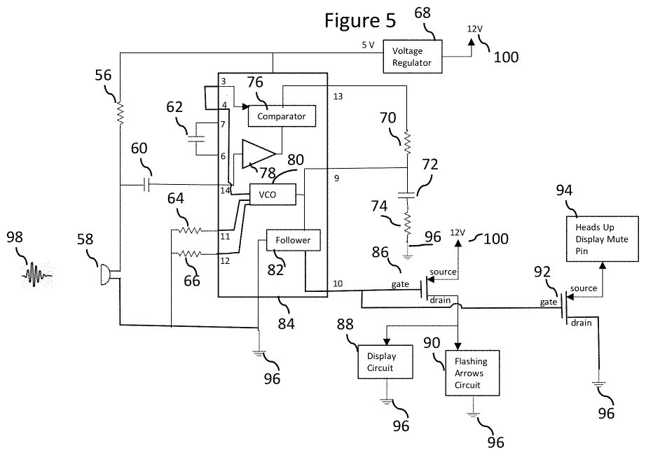

FIG. 5 generally shows a schematic of an emergency vehicle audio detector apparatus. A signal 98 goes into at least one microphone 58. The at least one microphone is grounded 96. The at least one microphone is connected in serial to a resistor 56. The resistor 56 is connected to a capacitor 60, a 5-volt voltage regulator 68, and a power input to a phase lock loop integrated circuit 84. The voltage regulator 68 takes 12-volt source 100 and regulates it to 5 volts. 12 volts is the standard power source in an automobile battery. The capacitor 60 is connected to pin 14 of the phase lock loop circuit. Pin 7 of the phase lock loop integrated circuit 84 is connected to a capacitor 62. Capacitor 62 is also connected to pin 6 of the phase lock loop integrated circuit 84. Pin 11 of the phase lock loop integrated circuit 84 is connected through a resistor 64 to ground 96. Pin 12 of the phase lock loop integrated circuit 84 is connected through a resistor 66 to ground 96. Pins 4, 11, and 12 of the phase lock loop integrated circuit are connected internally to the input of a voltage control oscillator 80. Pin 14 of the phase lock loop integrated circuit 84 is connected internally to an amplifier 78. The output of the amplifier 78 is connected to a comparator 76 internal to the phase lock loop integrated circuit 84. The comparator is connected internally to pin 13 of the phase lock loop integrated circuit 84. The output of the voltage control oscillator is connected to a source follower 82, a type of amplifier called a MOSFET, with low impedance, internally to the phase lock loop integrated circuit 84 and to pin 9. Pin 13 of the phase lock loop integrated circuit is connected to a resistor 70 which is connected on another end to pin 9 of the phase lock loop integrated circuit 84. Pin 9 is also connected to a capacitor 72 and a resistor 74 in serial to ground 96.

The output of the follower 82, pin 10, is connected to a p-channel field effect transistor (PFET) 86. The source of the PFET 86 is connected to a 12-volt source 100. The drain of PFET 86 is connected to a flashing arrows circuit 90 and to a display circuit 88. Both the flashing arrows circuit 90 and the display circuit 88 are grounded 96. The follower 82 is also connected to PFET 92. A source of PFET 92 is connected to a heads up display mute pin. A drain of PFET 92 is connected to ground 96. A display circuit 88 displays a message such as “Emergency vehicle approaching” as shown in FIG. 2 and FIG. 3. The flashing arrows circuit 90 is present in some embodiments and displays an arrow to show from which direction the emergency vehicle is approaching. The heads up display mute pin 94 is present in some embodiments and is used to mute audio in a vehicle when an emergency vehicle is approaching. In some embodiments, the display circuit 88 could be configured with a speaker to emit an audible signal that an emergency vehicle is approaching. Signals from multiple microphones could be used to calculate the direction from which an emergency vehicle is approaching.

Although there have been shown and described the preferred embodiments of the present invention, it will be readily apparent to those skilled in the art that modifications may be made thereto which do not exceed the scope of the appended claims. Therefore, the scope of the invention is only to be limited by the following claims.

I claim:

1. An emergency vehicle audio detector apparatus which consists of a phase lock loop which is connected to an appropriate power source and at least one microphone with appropriate resistors and capacitors to output a signal through a transistor to a display circuit which displays a message.

2. The emergency vehicle audio detector apparatus of claim 1 wherein there are a plurality of input signals from a plurality of microphones and the output signal triggers a flashing arrows circuit to show from which direction an emergency vehicle is approaching.

3. The emergency vehicle audio detector apparatus of claim 1 wherein the output signal triggers a heads up display mute pin to mute audio in a vehicle when an emergency vehicle is approaching.

4. The emergency vehicle audio detector apparatus of claim 1 wherein the output signal triggers an audible alert.
